(19) United States
(12) Patent Application Publication
(10) Pub. No.: US 2010/0189536 A1
(43) Pub. Date: Jul. 29, 2010

(54) Method and device for forklift blade

(76) Inventors: Avram Morgan, Hadera (IL); David Sasson, Kiriat Ata (IL); Oshri Morgan, Bait Eliezer (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 12/692,661

(22) Filed: Jan. 25, 2010

(30) Foreign Application Priority Data
Jan. 26, 2009 (IL) 196713

(51) Int. Cl. B66F 9/12; B66F 9/18

(52) U.S. Cl. 414/785

(57) ABSTRACT

The present invention innovates a method and device which enabling a solutions to the problems occurs while working with forklift lifting loads, and when forklift lift their loads, usually is by the two steel blades or arms connected to the forklift.

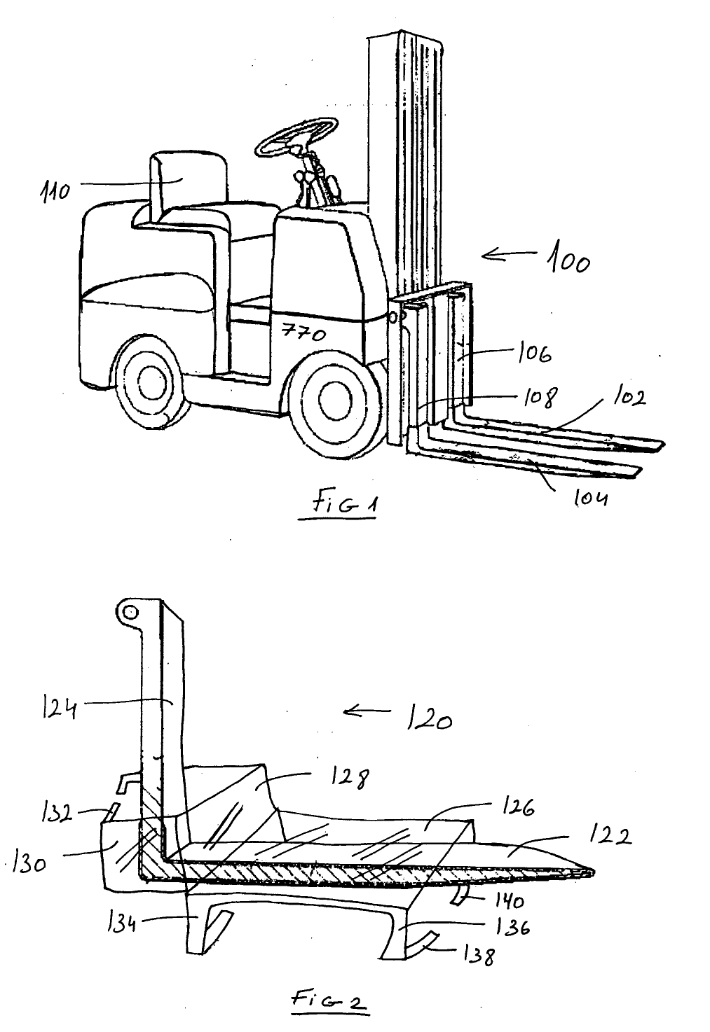

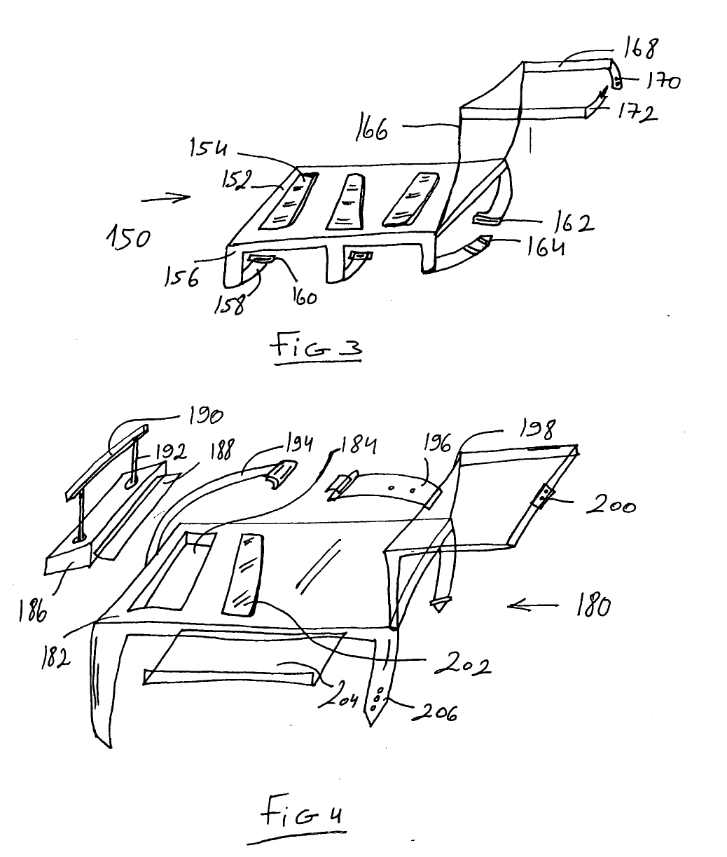

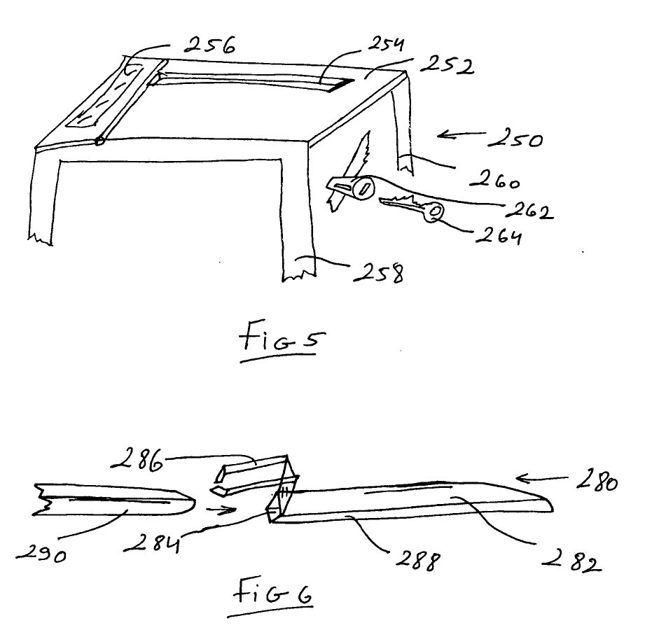

More specifically, method and device that allowing a connection or connector sleeve fitted to be attached at least on part or on a particular part of the surface of the forklift horizontal blades parts, and optionally, connected too to the blades vertical parts, of the ongoing horizontal bases. Wherein, the device consists of a base part that enabling connecting and disconnecting of different parts and tools to and from it.

The connecting parts that can be add to the base part, to the connector, are varied, and have different parts characters, fitted and can be changed in view of different needs of the specific action, or operation of each specific forklift task. Wherein, the device enabling the connection of the base part to the forklift blades, and to that base, the different tools are to be connected in an easy and fast connecting and disconnecting method.

Connection made possible in a modes that allow adding alternative part or tool, for helping or securing the task purpose. Wherein, the invention provides effective solutions to enhance work safety of the human factor, and for the human factor and mechanical needs of variety of actions dedicated for different possible working action executed by forklifts.

### BACKGROUND OF THE INVENTION

The present invention is in the field of forklift, and in more details, it is a method and device that allow creating an additional or alternative a connector that connect to forklift arms balanced vertically, while enabling matching and connecting, or disconnecting, an additional connecting parts, each for different task, designated for different work made by forklift.

Forklift is a motorized vehicle used for loading cargo in short distances, by the steel blades, fork or metal teeth, in a way of entering the blades under the loading cargo or object, to lift the load to a second position, to the load destination, for example, from the storeroom to the truck transporter.

Forklift was invented in 1917 by a company that manufactures transmissions parts, in order to ease the movement of spare parts, heavy parts and tools, from one place to another. Since that time, the forklift becomes equipment necessary for industry and commerce: in particular the ongoing operation of production plants, workshops and warehouses.

Forklifts are not considered as a tool suitable for all ordinary people, such as an inexperienced person. Forklift are dangerous tools, anyone not skilled in operation them, may damage the merchandise and the baggage loaded by them, and more over, drags a danger to the body and those around him.

Forklifts are divided to categories, according to the maximum load, and their forward center of gravity. Loading is forbidden to pass the limits specified in the instructions. Weight lifting as an example, over the manufacturer's instructions, can end in falling tendency of the forklift through the load direction. Moreover, such situations may even endanger the human operator that operates the forklift by losing control on the Forklifts balance.

Critically important feature related to the forklift, is the instability of the forklift, also related to the different steering of the forklift, from the steering usually practiced by the vast majority of drivers in a road vehicles.

One has to consider the forklift and its load as a one unit, which the center of its gravity is constantly changing, with every movement of the freight. It is forbidden to accelerate the forklift at a turn, because centrifugal and gravity forces can create a dangerous overturning accident. It is forbidden to use a forklift as elevator lift to lift humans, unless it was designated with appropriate equipment for that purpose.

United States and other countries enacted a special laws relating to driver's and license designated special traffic safety for directing forklift driving and traffic loaded machinery.

The vast majority of forklift consist a blades or arms made 10 out of metal, and dedicated for lifting loads. The Forklifts arms themselves, are controlled by a lever lifting parameters, as to their height adjustment and the positioning of them respectively to the needs of the work that is to be done. Therefore even some control over the angle of the blades.

These arms characteristically include an exposed metal surface, wherein, lifting loads to the stacked is manually operated by human porters, to a device such as wooden surfaces. The wooden surfaces, including lower openings that allow the arms to the Forklifts to get inside and under the surface to the point that creating space between the surfaces. The blades should get inside until it reaches the point of equilibrium that is safe enough to act the lift of the weight. Wherein, the surface itself, such as the wooden surfaces, gives a partial required protection answer to the delicate loads loaded by the forklift arms, wherein, many loads are often fragile, or a costly, or even dangerous materials.

It seems that there is a need for forklift arms that will includes a connecting device that is to be connected to the arms and blades of the forklift, and will enables to a variety of tools to be connected ad disconnected from the blades in a fast and easy manner, and respectively, the tools will be chosen as to each specific task standing in front of the user. It will increase the safety in operating works whit Forklifts, it will ease the work from human porters, it will make the services and the products less inexpensive, and it will be more efficient for the employers.

### SUMMARY OF THE INVENTION

The purpose of the present invention is to provide a method and device that safety and efficiency provides solutions to problems accurse in loading cargo by forklift. Particularly, loads that made directly by the forklift steel blades.

The method and the device allows the base portion, a connector, to be connects to the forklift blade, and to be connected to at least a partial area of the blade surface area, whereby, allowing for a matching connector tools, each tool at a time, chosen for a specific task, to be connected and disconnected to the base portion. Wherein, the tools parts are adapted to specific needs and goals of the work required to be preformed. Wherein, the base portion of the connector, secures to the forklift blades in the horizontal blades location, or even in the vertical blade base.

The base portion of the connector includes a means to be connection and secured to the forklift blades, from one side, and from another side includes connecting means to connect the tools parts.

Wherein, the base portion of the connector connected to the forklift steel blades can be removed from the forklift steel blades, however, the base portion with its connecting means, enabling easy and fast connecting and disconnecting of tools parts to the base when it is connected to the forklift steel blades.

Connecting the base portion to the tools portion can be preformed in the way of different fast connection that are existing, for example, as a connecting means securing the drill and the drill bit, by screwing, by locking mechanism, and by attaching solutions, for example.

### BRIEF DESCRIPTION OF THE DRAWINGS

The drawings accompanying this invention are to provide additional understanding of the invention. The drawings show various manifestations of the invention and together with the description, serve the purpose of explanation of the principles of how to perform the invention, and all through are an examples, and not to limit the invention only to these descriptions.

Drawing 1 is a schematic illustration of an example of a description included in the application of the present invention which shows an example of forklift blades and installation of the forklift as in the observes drawing.

Drawing 2 is a schematic illustration showing an example of a description included in the application of the present invention which shows an example of a standard forklift blade with a connector or adapter which is part of the present invention includes a device connector connecting to the forklift blade secured in the lower horizontal blade and to the perpendicular blade too as observed in the drawing.

Drawing 3 is a schematic illustration showing an example of a description included in the application of the present invention which shows an example of a connector which is part of the present invention includes a device connector fitted to be secured to the forklift blade area in the lower horizontal blade and at the perpendicular blade area, that is an extension of the blade lift, with connecting means as seen in the drawing example.

Drawing 4 is a schematic illustration showing an example of a description included in the application of the present invention which shows an example of a connector of the present invention includes connector fitted to be connected to the horizontal and vertical blades with the connecting means as in the example of the drawing, wherein, the connector includes in it's a connecting means enabling connecting and disconnecting of tools dedicated for different type of works.

Drawing 5 is a schematic illustration showing an example of a description included in the application of the present invention which shows an example of a connector of the present invention includes a device connector fitted to be secured to the horizontal and vertical blades with the connecting means such as securing key and lock enabling the opening and the closing of the connector of the present invention.

Drawing 6 is a schematic illustration showing an example of a description included in the application of the present invention which shows an example of a connector fitted to be secured to the horizontal and vertical blades with connecting means as seen in the drawing example.

### DESCRIPTION OF THE PREFERRED EMBODIMENTS

drawing 1 shows an example of a forklift 100 and lifting blades 102 and 104 designate to be lifted by forklift 100 by the blades of the forklift 102 and 104, when all of the horizontal blades 102 and 104 ending in a right angle that rising up, in a vertical shape 108 and 106 and those connected to the forklift 100, allows to the forklift 100 operator that sitting in the chair 110 to start lifting or lowering, or tilting angle of the blades 102 and 104 of the forklift 100 respectively to the different loads.

Drawing 2 shows blade device 120 that is designed to lift loads and handling them, forklift blade is an example of a device 126 of the present invention, wherein, the device connector 126 seems transparent in the drawing, only for the purpose of more easily understanding the drawing.

This implementation of the invention includes at least connecting device that connects the upper part of the forklift blades 122, and includes connecting means that enabling its securing around the blade 122, wherein, the device has means of connecting and securing using strips 138 and 140 that are extensions of strips 136 and 134 connected to the top of the connector.

Forklift continues blades 122 ends in a right angle to a continues rising vertical extra unit of metal 124 such as steel, which enabling in the present invention the connection of the connecting device also at list in part, to the vertical standing blade part 124 by the connector parts 128 and connector areas 130 and -132.

Connecting the device connector to the blade 122 of the forklift, allows in the application shown here as an example for proper connection, quickly and efficiently of the connector to the forklift blades 122, wherein, the surface area of the device 126 will be at least partly with a configuration or features or characters of materials, that help to perform specific task jobs, As an example, such materials that can protecting also the forklift blades and the loaded cargo, as an example when at least part of their surface made out of rubber or rubber-featured prevent damage such as from blow, however, also secures the freight slipping out of the blades.

Drawing 3 shows the connector 150 of the present invention as an additional application as possible in drawing 2 of the present invention a connecting options of connector 150 to the forklift blade, in a similar ways as stated by drawing 2 with members 162 and 164, and with connecting means 170 with 172 members continue to the perpendicular blade.

a means of closing device connector 150 also include a demonstration of other strap that help secures, such as strap 158 that designated to supposed and connect to the bottom of the forklift blades, and straps and parts and connections 156 supposed to cover the inside sides of the forklift blades, when the invention enabling for example, closure straps 158 or 168 as a simple means of connecting as in buckle closer 160. Device area 166 allows additional connections of the device 150 to the forklift blades for additional securing, and for the purpose of preventing damage to the cargo in tim of slipping on the smoothing blades. Device surface that covers the upper part of the horizontal blades 152 would be a central part and will have much of the heavy pressures of the loads, because that is part has on it a direct and permanent contact with the loads piled on him, including the implementation of this part of the current invention, such parts that can be part 154 and another parts could be with feature type material such as rubber or have a configuration specification prominent or rough for the purpose of preventing sliding load burden.

Drawing 4 is a schematic descriptions that illustrates an example includes in the present invention which shows an example of the connector 180 of the current invention, includes a device connector 180 for securing to the forklift horizontal and vertical blades, this by connecting means as in the example of the present drawing. Wherein, the connector observed in drawing 180 including in its surface a connecting means 184 that enabling the connecting and disconnecting of different tools 186 to the connector 180. Connecting base device 180 that connected to forklift blades can be secured not in a manner that requires constant removal, because device 180 is the basis part, and it has the ability to be a connecting base to at list one 184 connector that enabling more tools connecting 186 and specializing connectors that are dedicated for specific purposes, each to his goal. Wherein, part 188 securing part 184 to part 186 and lookout that part from departure from it, as parts 190 and 192 securing the loads that are on the blades forklift, that prevents exit or fall of the loads, as also allow lifting a larger loads with larger surface area. Device 180 also allows the types of materials that allow configuration 202 or configuration features to help by different types of material freight lifting. Additional efforts made possible by a device 180 as an example of the device perpendicular to the blades 196 and on to the next part of the device 180 in contact with horizontal blades 182 and by a connection means such as belt connections 194 with belt 196, thereby allowing the closure of the load and preventing it from falling. Closing means 198 and 200 closes the part of the device 180 around the forklift blades facing the closing means 206 and 204 as an example of closing the device 180 on the forklift horizontal blades.

Drawing 5 shows a schematic a description example, includes a connector device 250 dressing or connecting to the forklift blades. As part of the present invention the device connector 250 designated for securing to the forklift lower blade and in their lower perpendicular area to an extension of the blade, connected by means such as lock 262 key 264 that connected to straps 258 and 260 for an example. Wherein, the device 250 includes a connection means 254 which allow connection of more and other devices and tools, and the ability to fast and easy removal of them according to the needs and goals of works required.

Drawing 5 shows a schematic a description example, includes a connector device 280 of the present invention, includes a connector base device in the pocket of the lower blade parts 282 and 288 on blade 290 for example, and securing it in the area of the perpendicular part by connecting means 286 and 284 as shows in the drawing.

1. A connecting device fitted to be attached or to be connected on at least one blade of a forklift, including in part of its surface connecting means that enabling the connection of at list one more connector, or tool, with different features or different configurations, to the device, by selecting connector or tool out of different type of tools or connectors accordingly to the different purposes or loads requirements and needs, when the facility consists of the following components as follows:
A. a device connected to at least one blade of a forklift blades, and that covers at least some part from the top part of the forklift blades, and that has on his surface a connecting means that enabling to connect to him at list another connector or tool, in order to address additional needs to those characters and needs existing in the metal blades of a forklift;
B. When the device has securing options and connecting means to the forklift horizontal blades or forklift perpendicular blades;
C. When the upper part of the device is in contact with raised loads loaded on the forklift blades, including at least one of the components are listed as follows:
The components of a configuration that prevent falling or sliding of loads raised by the forklift blades; components designated types of material to secure or prevent damage to the merchandise on the forklift blades, or to human safety, or to improvement of the work;

2. A device as claimed in claim 1, wherein the device consist from at list two parts, a base portion connected to the forklift blades, a seconded portion that is a tool connected to the firs part, and the device and its two parts, enabling a fast connecting and disconnecting the second part from the first part, whit the option to replace the second part by another connecting part fitted for different needs.

3. A device as claimed in claim 1, wherein the device consist from device fitted to be attached or to be connected on at least one blade of a forklift, including in part of its surface connecting means that enabling the connection of at list one more connector, or tool, with different features or different configurations, to the device, by selecting connector or tool out of different type of tools or connectors accordingly to different needs, wherein, the connecting means includes at list in part, one of the following: covering onto the forklift blades, a magnetically connecting means, connecting strap, screwing connector, catch or clip fitted to the other part, depression in one part that at list part of another part of the device is fitted to get in and be secured.

4. A device as claimed in claim 1, wherein the device consist from at list tree parts, a base portion connected to the forklift blades, a seconded portion that is a connector between the first portion and the third portion, and a third portion that is a tool connected to the second part, and the device and its tree parts, enabling a fast connecting and disconnecting of the third part from the second part, with the option to replace the third part by another connecting part fitted for different needs.

5. A device as claimed in claim 1, wherein the device connected permanently to the forklift blades at the manufacturing process, and at list one more portion can be connected to the first portion, and the device performs at list one connecting method that enabling connecting and disconnecting of parts or tools that are to be effective and helpful to work performances by forklift blades.

6. A device as claimed in claim 1, wherein the device enabling connecting and disconnecting parts and tools and the selection of each parts and tools is for their character, or their material, or for their shape, and its relevancy to a specific work performance required to be done by forklift blades.

7. Method and system that allows a method of connecting means to forklift blades, wherein, the method include connecting first base device fitted to be attached or to be connected to the forklift blades, on at least one blade of a forklift, including in part of its surface connecting means that enabling the connection of at list one more connector, or tool, with different features or different configurations, by selecting connector or tool out of different type of tools or connectors accordingly to the different purposes or loads requirements and needs, when the facility consists of the following components as follows:
A. a device connected to at least one blade of a forklift blades, and that covers at least some part from the top part of the forklift blades, and that has on his surface a connecting means that enabling to connect to him at list another connector or tool, in order to address additional needs to those characters and needs existing in the metal blades of a forklift;
B. When the device has securing options and connecting means to the forklift horizontal blades or forklift perpendicular blades;
C. When the upper part of the device is in contact with raised loads loaded on the forklift blades, including at least one of the components are listed as follows:
The components of a configuration that prevent falling or sliding of loads raised by the forklift blades; components designated types of material to secure or prevent damage to the merchandise on the forklift blades, or to human safety, or to improvement of the work;
